(19) United States
(12) Patent Application Publication
(10) Pub. No.: US 2011/0010213 A1
(43) Pub. Date: Jan. 13, 2011

(54) METHOD FOR CAPTURING AND REPORTING RELEVANT CROP GENOTYPE-SPECIFIC PERFORMANCE INFORMATION TO SCIENTISTS FOR CONTINUED CROP GENETIC IMPROVEMENT

(75) Inventors: Todd A. Peterson, Johnston, IA (US); Donald P. Avey, Ankeny, IA (US); Phillip Lee Bax, Johnston, IA (US); Annette Ackerson-Waldorf, Urbandale, IA (US); Warren Richardson, North Mankato, MN (US); Douglas J. Houser, Johnston, IA (US); Lisa Baumhover, Woodward, IA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: PIONEER HI-BRED INTERNATIONAL, INC., Johnston, IA (US)

(21) Appl. No.: 12/833,840

(22) Filed: Jul. 9, 2010

Related U.S. Application Data
(60) Provisional application No. 61/224,228, filed on Jul. 9, 2009.

(51) Int. Cl. G06Q 10/00

(52) U.S. Cl. 705/7

(57) ABSTRACT

A system for obtaining crop data from crop growers and using the crop data to assist in providing crop genetic improvements is provided. The system receives, from a producer or crop grower, geo-referenced crop data that indicates a yield of a crop at a production location and a particular hybrid or variation of the crop at the production location. The genetic element data is associated with the geo-referenced crop data. Performance data is then determined which indicates the performance of a genetic element of a crop, based on the association of the genetic element data with the geo-referenced crop data.

### CROSS-REFERENCE TO RELATED APPLICATIONS

This application claims the benefit of U.S. Provisional Application Ser. No. 61/224,228 filed Jul. 9, 2009 which is incorporated herein by reference in its entirety.

### BACKGROUND

What is needed is a way to provide crop performance data from grower's production fields and environments, organize the data, associate the data with a physical, environmental, and/or pest incidence information, analyze the data, and communicate the data to plant scientists to assist in crop genetic improvement.

### SUMMARY

According to one aspect, a method may include receiving, from a producer, geo-referenced crop data that indicates performance of a crop at a production location and an identity of the crop at the production location. The method may also include associating genetic element data with the geo-referenced crop data. The method may further include determining performance data for a genetic element, based on the association of the genetic element data with the geo-referenced crop data.

According to another aspect, a method for providing feedback to a plant research system to assist in crop genetic development is provided. The method may include collecting multipoint geo-referenced crop data, wherein the crop data include yield data and plant or crop identification data. The method may further include associating genetic element data with the crop data, and providing the genetic element data and the crop data to the crop research system to assist in evaluating performance of seed products as grown.

According to another aspect, a method for providing feedback to a crop research system to assist in crop development is provided. The method includes receiving multipoint geo-referenced crop data, wherein the crop data includes harvest data and linking at least one genetic element with the crop data. The method further includes storing at least a subset of the harvest data in a research database associated with a crop research system, and performing an analysis of the crop data using the crop research system, the analysis indicative of performance of one or more genotypes having at least one genetic element.

### BRIEF DESCRIPTION OF THE FIGURES

FIG. 1 is an overview illustrating one process and system for obtaining crop data from growers and using data to assist in crop genetic improvement.

FIG. 2 is a block diagram showing crop data from growers being used in crop research.

FIG. 3 shows a method of using crop data from growers in research to improve crop genetics.

FIG. 4 is a block diagram showing an example of a method.

FIG. 5 illustrates an example showing genetic element data associated with crop data acquired from a grower.

FIG. 6 illustrates an annotated aerial map which includes summary data for multiple different fields.

FIG. 7 is a block diagram representing a computer system in which aspects of the present invention may be incorporated.

### DETAILED DESCRIPTION

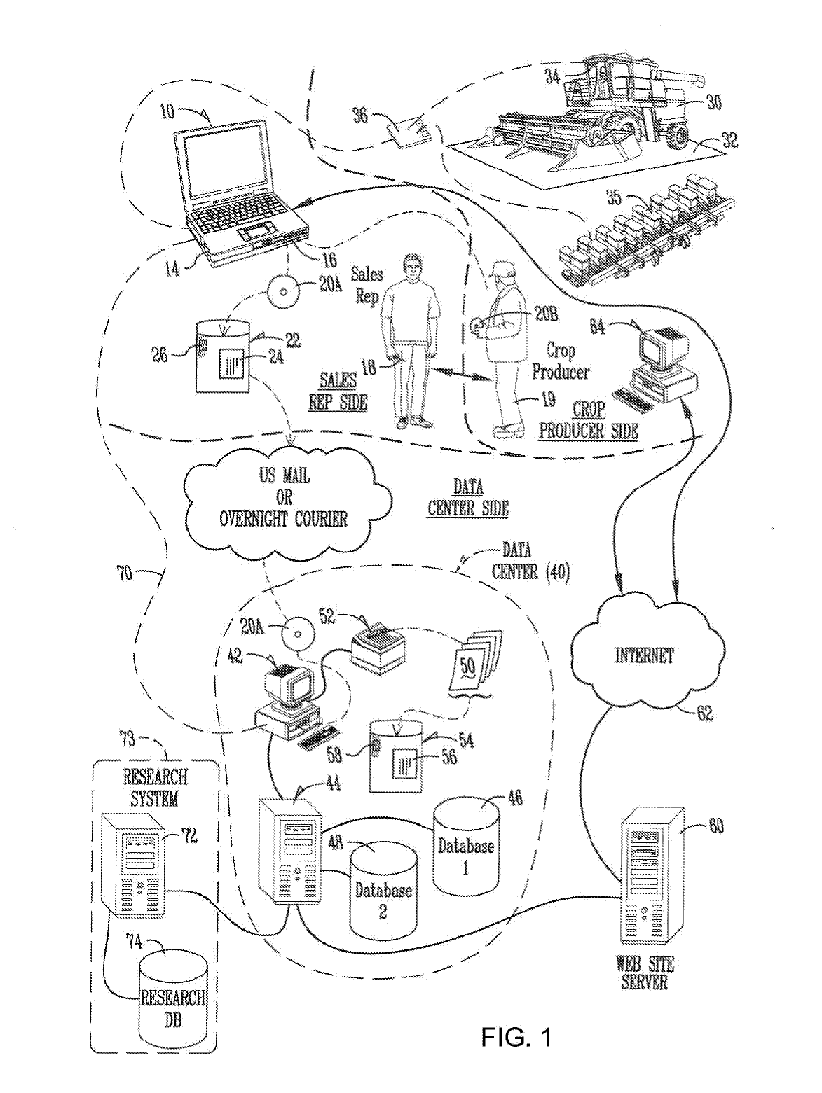

FIG. 1 illustrates a process and system for obtaining crop data from crop growers and using the crop data to assist in providing crop genetic improvements. A process and system for providing crop producers with yield maps is described in U.S. Patent Application Publication No. 2006/0282467, herein incorporated by reference in its entirety.

As shown in FIG. 1 a computer 10 is shown which is associated with a sales representative 18 or other person associated with a seed company such as an agronomist, account manager, or seed company employee. The sales representative 18 may work with a crop producer 19 to assist the crop producer 19 in selecting and/or obtaining hybrid or varietal seed for planting. The sales representative 18 may obtain crop data associated with the field 32. For example, the crop data may be collected using the harvesting system 30 and/or planting system 35. The sales representative 18 may obtain crop data directly from the crop producer 19 after it has been collected. The crop data may include harvest data such as associated with harvesting system 30 and/or as-planted data such as associated with planting system 35. For example, the crop data may include grain moisture data, hybrid or variety data, yield data, and/or other data that may be retrieved during planting or harvesting. In addition, the sales representative 18 or other person associated with the seed company may also collect data other than harvest data or as-planted data. Examples of other types of data may include grower suitability ratings, observations, crop management practice data, hybrid and/or variety identification data, and/or field location data.

In addition to crop data, production location data may also be collected. Production location data may include data which is indicative of a geographic location or an attribute of a geographic location, such as GPS coordinates, the size of a field, elevation, soil type, weather information, or the like. The production location data may be included in the crop data or may be collected independently; therefore any reference to crop data may also include production location data. The harvesting system 30 and/or planting system 35 may include a GPS receiver, such as GPS receiver 34, to identify field locations within a field 32 which may be collected in addition to crop data. The harvesting system 30 and/or planting system 35 may be, for example, precision agricultural systems. The harvesting system 30 and/or planting system 35 may use such technologies as Geographical Information Systems (GIS), Global Positioning Systems (GPS), differential GPS, sensors, variable rate technology (VRT), satellites, aerial images, electrical conductivity maps, equipment mounted crop sensors, crop canopy sensors, and/or yield monitoring (YM). Using GPS technology, sensors, or other precision agricultural equipment may allow crop data to be collected in various ways. For example, crop data may be associated with a production location, such as the location of a field or a portion thereof, such as the location of a row of a field, a portion of a row, an individual crop or seed location, or the like.

Where location data is used in conjunction with other data at multiple points the resulting data may be described as being geo-referenced multipoint data. Any reference to crop data or geo-referenced crop data herein may also include the geo-referenced multipoint data associated therewith. The crop data may be stored on a computer readable medium such as a memory card 36 or the like. The crop data may include as-planted data and/or harvest-related data such as described herein. The crop data may also include data indicating one or more environmental attributes at the production location. For example, the crop data may include weather data, soil moisture data, precipitation data, drought index data, solar radiation data, photoperiod data, latitude data, elevation data, soil type data, climate data, humidity data, temperature data, and/or other environmental characteristics associated with the production location. Environmental attribute data may include historical data, average data, cumulative data, and/or current data, or any combination thereof, of the environmental characteristic associated with the production location. In one example, cumulative environmental data may include heat units and/or growing degree units (GDUs). In some examples, one or more types of environmental attribute data associated with the production location may be collected independently and may not be included in the crop data.

The sales representative 18 may obtain the crop data from the crop producer 19. For example, the sales representative 18 may insert the card 36 into a corresponding card slot 14 on the computer 10, and then copy the crop data from the memory card 36 to the computer 10. Alternatively, the data may be obtained in other ways such as wirelessly, or by allowing the crop producer 19 to submit the data electronically to a web site. The sales representative 18 may also supplement the crop data with additional information. For example, the sales representative 18 may supplement the crop data with an identity of the crop, such as a hybrid or variety name associated with the crop data, where such data is not included in the crop data. In addition, the sales representative 18 may also be able to provide data associated with the field, the location, and/or the genotype which the sales representative is able to obtain from the crop producer or from any other source. For example, crop management practice data, such as plant population or nitrogen fertility associated with a field area, may be obtained from the grower or other sources. Grower reactions to suitability of a hybrid or variety to a particular field, environment, or crop management practice may also be collected.

The crop data may be provided to the seed company. The sales representative 18 may convert the crop data using the computer 10 to provide the crop data to the seed company. For example, the crop data may be provided to the data center 40 using CD, direct data transfer, or other methods for providing data to a data center. The sales representative 18 may also provide the crop producer with a copy of the data. For example, the sales representative 18 may provide a copy of the data on a computer readable medium such as a CD 20B. The seed company databases may provide for storing the crop data received. The data center servers 44 and other associated databases may also be in operative communication with other servers within the seed company. For example, the data center servers 44 may be in operative communication with research servers 72 which may be a part of a crop research system 73. The research servers 72 may be associated with plant research and/or the development of improved genetics for hybrid or variety seed products. Harvest data and/or other crop data, or a subset of such data may be stored in a research database 74 in operative communication with the research servers 72 within the research system 73. Having the actual production data may provide a research organization of a seed company with a better understanding through real world examples of how products are performing on a large scale, in geographically diverse locations, in a variety of soil types, and/or under a variety of different environmental conditions, and/or in specific crop management regimes. The data center servers 44 and other associated databases may also be in operative communication with seed production servers, sales and/or marketing servers, or other servers within a seed company.

A web site server 60 may also be in operative communication with the data center servers 44. The web site server 60 is operatively connected to the internet 62. A crop producer 19 may use a computer 64 to access information through the web site server 60. The crop producer 19 may also provide feedback to the seed company about the genotypes being produced. The information that may be accessed by producer 19 may include crop data collected by the producer, crop data associated with the crop producer's field, agronomic data, phenotypic data, such as plant height or ear height, and/or one or more yield maps or other harvest maps. The yield maps or other harvest maps may include maps such as grain moisture maps, residue produced maps, and/or maps of the amount of field lodging for example.

Although FIG. 1 illustrates data transfer from a harvesting system 30 and/or planting system 35 through use of a computer readable medium such as a memory card 36, this information may also be electronically communicated such as to the computer 64 and then from the computer 64, through the internet 62 and/or the web site server 60 to the data center servers 44. In such an example, the web site may allow another way for the harvest data to be supplemented if necessary, with hybrid or variety data and/or other data of potential interest such as trait data, observational data, management practices, soil type data or other environmental data. In such an example, the sales representative may not necessarily collect the data.

Thus, as shown in FIG. 1, a system may collect geo-referenced crop performance data from crop growers, provide a way to specify the genotype planted in each location within the field (even when not a part of yield data), process the data to identify genotype by performance data coming into the data center, package it into a useable format, and relay the data to research on an ongoing basis.

The fields or areas within a field 32 which are used may also be fields which have additional ties to the seed company. For example, the fields may be fields which are used in trials under an agreement between the crop growers and the seed company. It is to be appreciated that there are many different types of field trials, production plans, and/or grower plans. Data may be collected from seed products during pre-commercial, commercial, or post-commercial time periods. For example, the field trials may involve commercial seed products or pre-commercial seed products. In addition, the fields may be a single genotype for a whole field, or include more than one genotype, with the field mapped in any different design, including but not limited to field map designs such as strip trials, split-planter, or large block configurations.

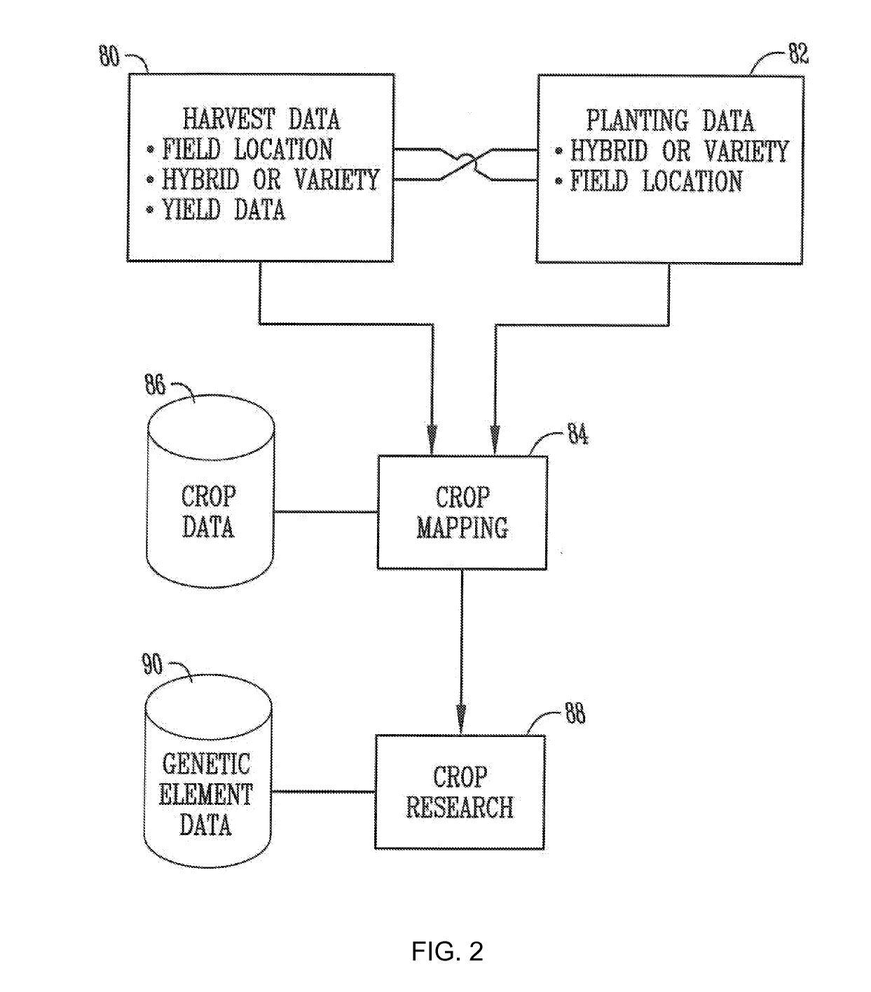

FIG. 2 is a block diagram showing crop data from growers being used in crop research. In FIG. 2 harvest data 80 is shown. The harvest data 80 may include yield data, field location, and/or hybrid or variety identifying information. Planting data 82 is also shown. The planting data 82 may include hybrid or variety identifying information and/or field location data. Additionally, trait and phenotypic observation data and crop management practices such as plant population associated with a field location may be provided. Typically the field location data is provided in terms of geospatial coordinates, such as those obtained through a GPS receiver.

The harvest data 80 and the planting data 82, if used, are provided to a crop mapping system or other geographic information system (GIS) 84. A crop mapping system 84 may store the planting data 82 and the harvest data 80 as crop data in a crop data database 86. A crop mapping system 84 may also generate yield maps for crop growers. The crop mapping system 84 may also transfer the crop data or a subset of the crop data to a crop research system 88 or other system within a seed company. The crop research system 88 may have access to a genetic element database 90 containing data describing the genetics associated with or included within different hybrids or varieties. By using hybrid or variety identifying information, the associated pedigree or other genetic information associated with a particular crop may be determined. The genetic element data may include such information as a particular gene within a seed product, a particular cDNA within the seed product, a particular genetic marker within the seed product, a particular locus within the seed product, or a particular set of genes (stack) within the seed product which confer a trait, or any other type of genetic construct within a particular seed product. Thus, the harvest data 80 and its relationship with the genetic information may then be analyzed through various methods. For example, the harvest data 80 may be analyzed together with the genotype data through statistical methods to provide additional insight into the performance of the genotype at a particular location and/or under particular environmental conditions and/or particular management practices. Crop management practices may include, but are not limited to, practices such as the application of various types of crop nutrients at various timings, the application of various types of pesticides at a variety of timings, chemical application methods and timing, tillage, irrigation, crop rotation, subsurface drainage, and refuge planting, for example. This may provide the crop research system 80 with additional information which can be used to suggest modifications to a particular genotype or genetic background to improve crop performance or to suggest breeding strategies to improve performance in a particular genotype, group of genotypes, or genetic element.

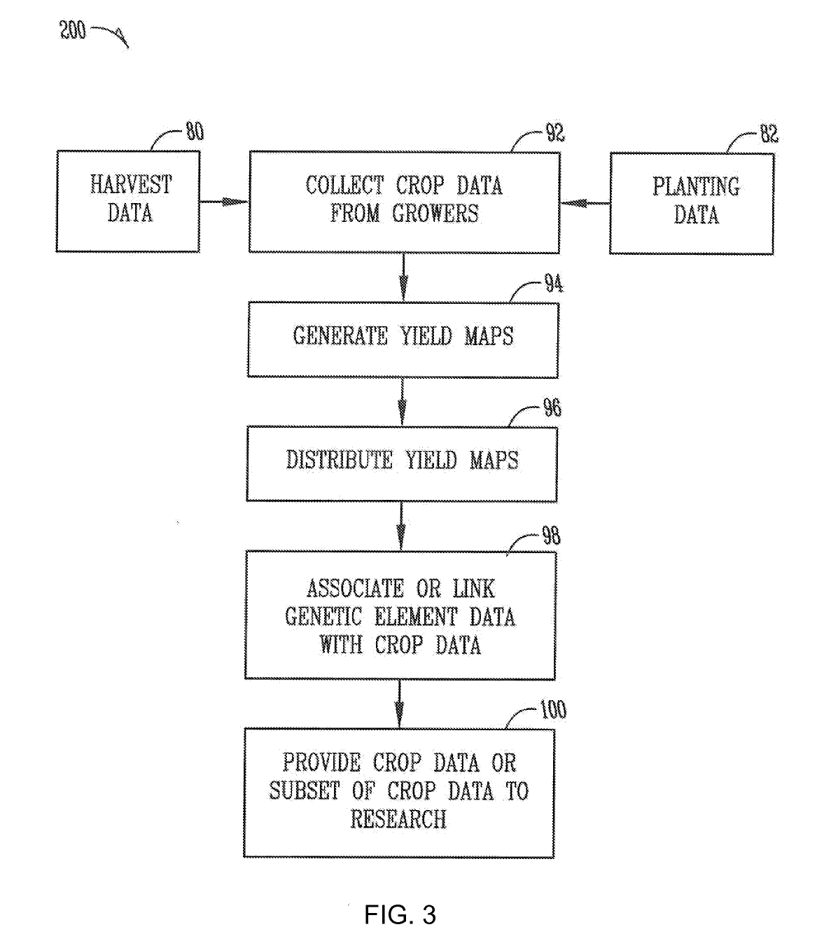

FIG. 3 shows a method of using crop data from growers in research to improve crop genetics. In step 92, crop data is collected from growers. The crop data may be harvest data 80, or as-planted data 82 and harvest data 80. The harvest data 80 and/or as-planted data 82 may be collected with the hybrid or variety of the crop or seed being identified. In step 94, the crop data collected from the growers may be used to generate yield maps and the yield maps may be distributed at step 96. For example, the yield maps may be distributed to the growers of step 92.

Where the harvest data 80 does not include any identification of the hybrid or variety being used, one way to supplement the harvest data 80 is to use corresponding planting data 82. The planting data 82 may include an identification of a hybrid or variety of seed which is planted that can then be associated with the harvest data 80 for the corresponding crop.

If planting data 82 does not exist or else if the planting data 82 also fails to sufficiently identify the hybrid or variety of seed being planted, then a seed company representative 18 may be able to supplement the data with the hybrid or variety of seed which was planted or harvested. The seed company representative 18 may obtain the hybrid or variety of seed planted and harvested directly from the crop producer. In some examples the data may be obtained as part of a yield mapping program.

In step 98, genotype data is associated with the crop data, physical data, environmental data, and other location data. The genotype data provides a genetic description or identity of a particular hybrid or variety of seed. In step 100 the crop data or a subset of the crop data is electronically transferred or otherwise provided to a research computer system 72. Not necessarily all of the crop data may be of use in a research program, thus data which is not of use in the research program may not be transferred. For example, harvest data 80 may include data regarding equipment, data identifying the crop producer, the crop producer's name of a field, and other data which may be removed from the data before being used in the crop research program.

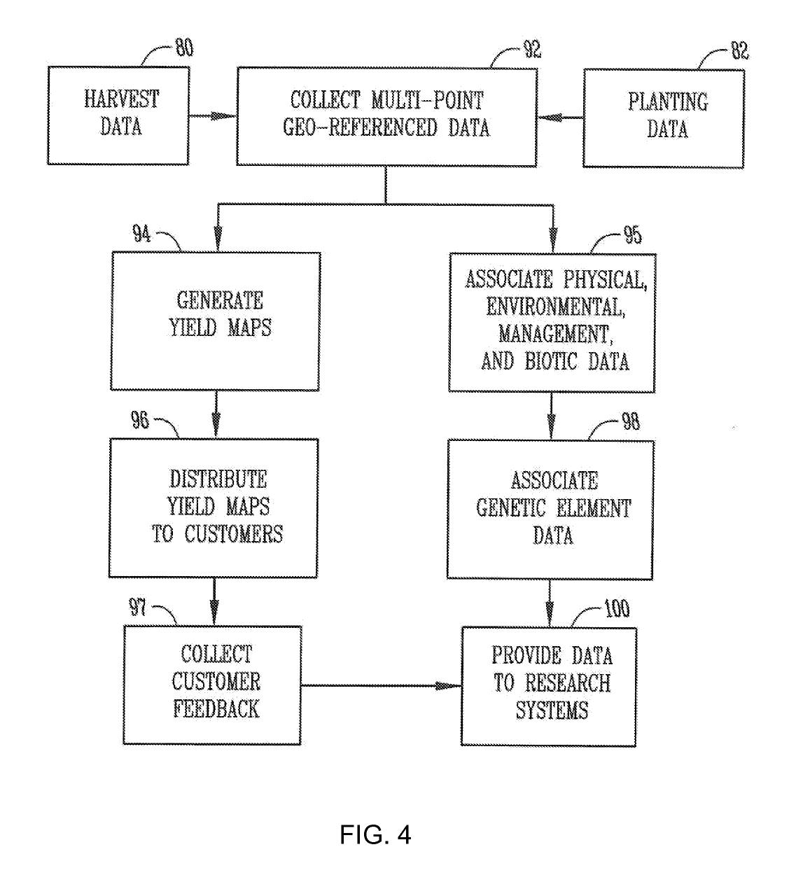

FIG. 4 is a block diagram showing an example of a method. In step 92, one or more of harvest data 80 and/or planting data 82 is collected. This data may be multi-point geo-referenced data such as may be acquired through precision agricultural systems associated with planters, harvesters, or other types of agricultural equipment. In step 94, yield maps (or other types of harvest maps) are generated using harvest data 80, and/or planting data, and multi-point geo-referenced data. In step 96 the yield maps are distributed to customers such as growers.

In step 95, additional data such as physical data, environmental data, management data, and/or biotic data may also be associated with the multi-point geo-referenced data. The environmental data may include data that indicates an environmental attribute at a location indicated by the multi-point geo-referenced data. The physical data, environmental data, management data, and/or biotic data may be collected from any number of sources, including from growers, landowners, government resources, third party resources, seed company representatives, or otherwise. In step 98, genetic element data 98 may be associated with the multi-point geo-referenced data (and other data, if available). The genetic element data may include such information as a particular gene within a seed product, a particular cDNA within the seed product, a particular genetic marker within the seed product, a particular locus within the seed product, or a particular set of genes (stack) within the seed product which confer a trait, or any other type of genetic construct within a particular seed product.

In step 97, grower feedback may also be collected and associated with the multi-point geo-referenced data. Grower feedback may be useful in many different ways. For example, growers may identify as important phenotypic information which would otherwise not necessarily be considered to be important to plant scientists. Grower feedback may include, for example, a grower's reaction to a crop, such as feedback regarding how the crop looked in the field or how the combine sounded when the crop was harvested. Grower feedback may include, for example, grower needs, such as better stalk quality, earlier maturity, improved ease of harvest, less residue, or the like. This feedback may assist a plant scientist in development of new seed products which meet grower expectations in these ways as well as more typical performance-related characteristics.

In step 100, data is provided to the research system(s). The data includes the multi-point geo-referenced data, any associated physical, environmental, management, and biotic data, as well as the associated genetic element data, and optionally any grower feedback information. Because the genetic element data is provided, the research system can use the genetic element data as one way of indexing data from growers or other disparate sources.

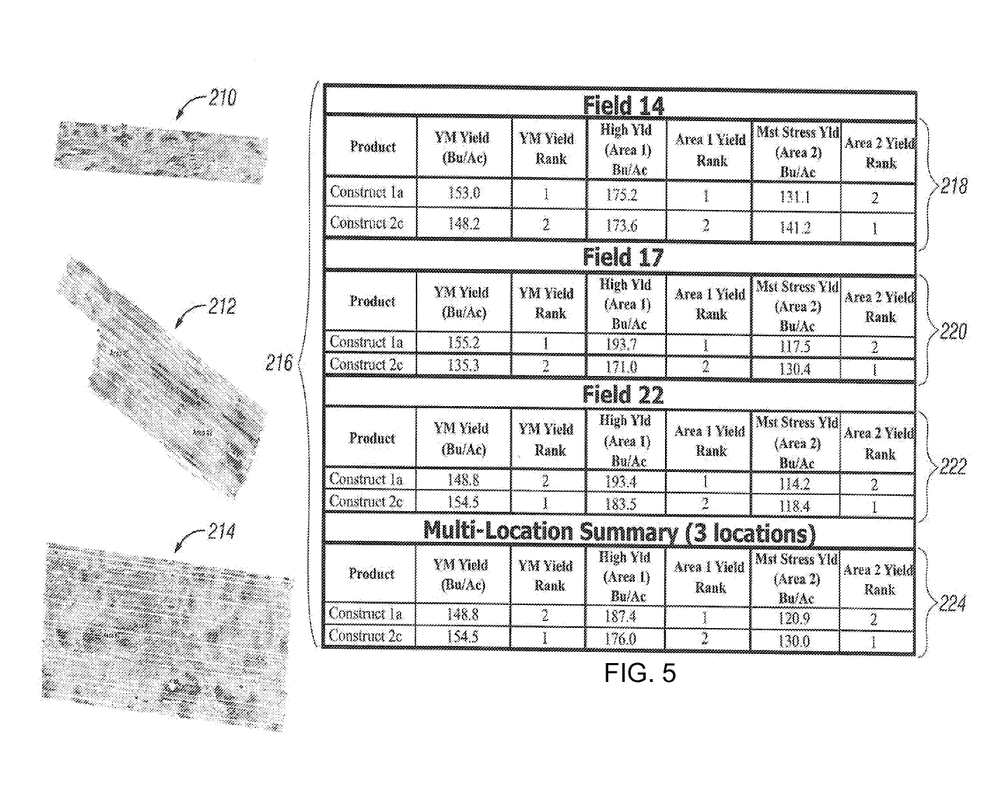

FIG. 5 illustrates an example showing genetic element data associated with crop data acquired from a grower. In FIG. 5, harvest map data is shown for a first field 210, a second field 212, and a third field 214. In addition, for the first field 210, associated data 218 is shown which includes genetic element data such as “Construct 1a” and “Construct 2c” as well as harvest data. For the second field 212, associated data 220 is provided. For the third field 214, associated data 222 is provided. In addition, summary data 224 is provided across the three separate field locations. As shown in FIG. 5, the performance of a crop comprising a particular genetic element may be compared in different fields, which may be at different locations, and may further represent different environments and/or environmental profiles.

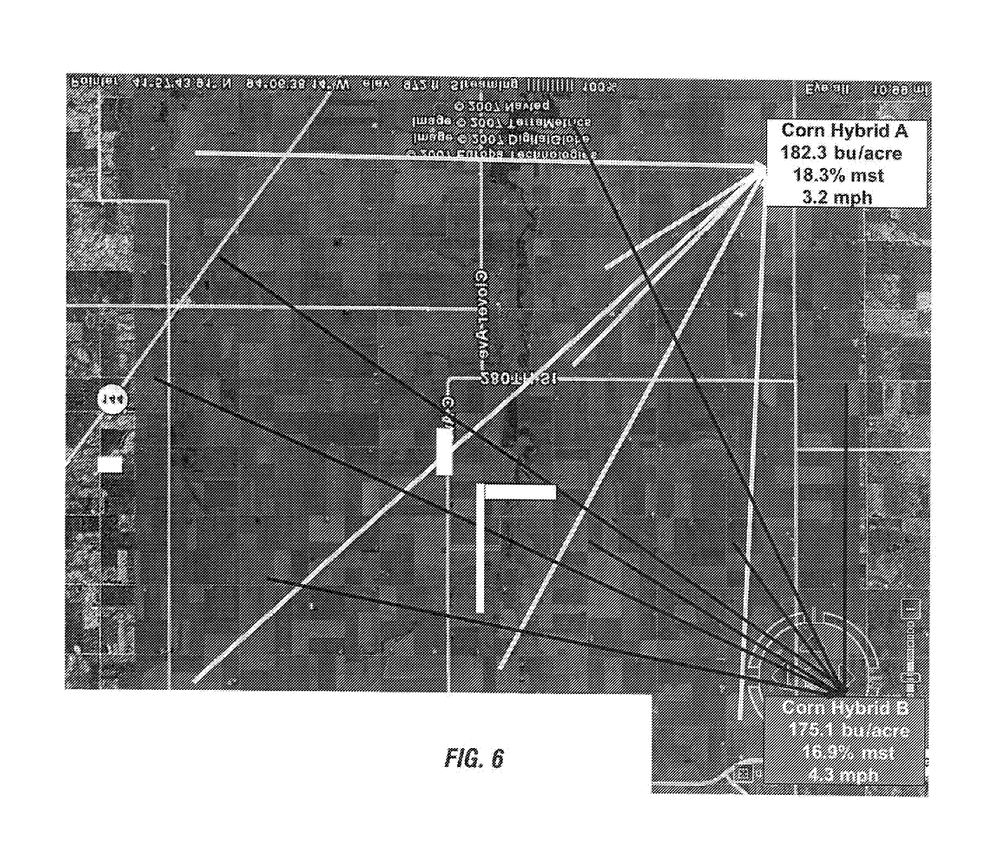

FIG. 6 illustrates an annotated aerial map which includes summary data for multiple different fields. In FIG. 6, a number of different fields with crops sharing a particular genetic element of interest are shown as well as associated harvest data such as bushels per acre yield, percent moisture, and combine travel speed. The combine travel speed can be used to evaluate product lodging/standability and/or ease of harvest. These criteria may be used as selection criteria for plant breeders and growers. FIG. 6 is merely one example of the way in which plant scientists using a research system may relate performance data to particular genetic elements of interest.

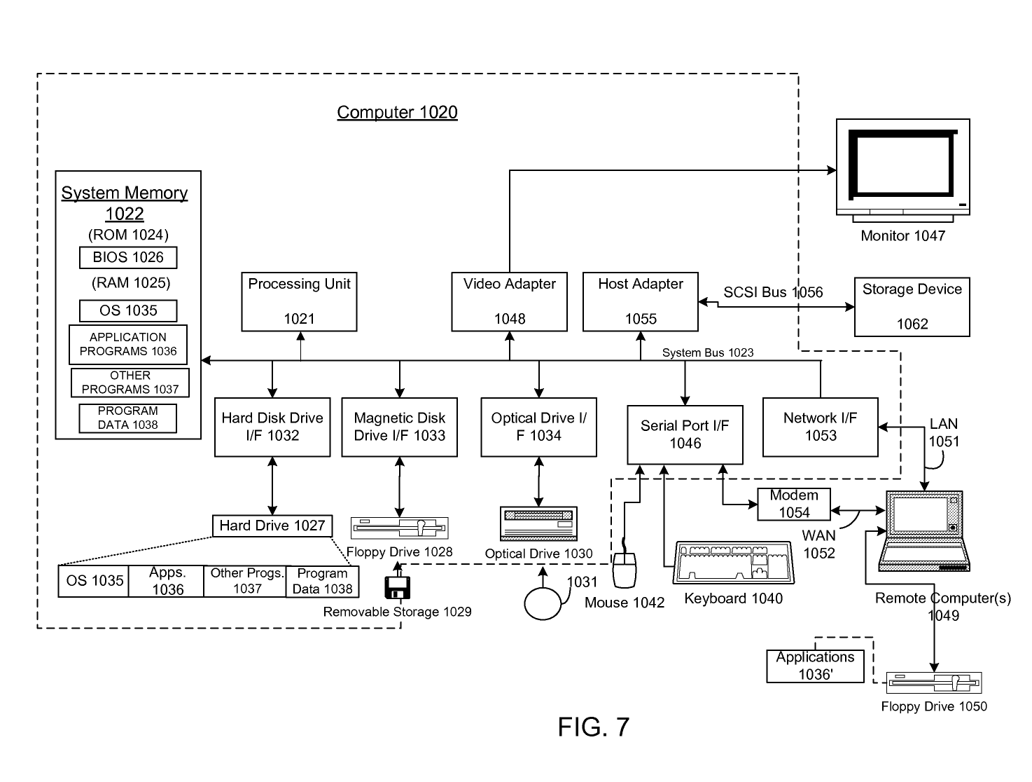

FIG. 7 and the following discussion are intended to provide a brief general description of a suitable computing environment in which the embodiments described herein may be implemented. For example, the block diagrams as illustrated in FIGS. 2-4, and as described herein, may be implemented, in whole or in part, as computer executable instructions performed on a computing environment as described below. Although not required, the described embodiments may be implemented in the general context of computer executable instructions being executed by a computing device, such as a client workstation or a server for example. Those skilled in the art will appreciate that the embodiments described herein may be practiced with other computer system configurations, including hand held devices, such as cellular phones, smart phones, PDAs, or the like, multi processor systems, microprocessor based or programmable consumer electronics, network PCs, minicomputers, mainframe computers, or the like. The embodiments described herein may also be practiced in distributed computing environments where tasks are performed by remote processing devices that are linked through a communications network.

Referring now to FIG. 7, an exemplary general purpose computing system is depicted. The general purpose computing system may include a conventional computer 1020 or the like, including at least one processor or processing unit 1021, a system memory 1022, and a system bus 1023 that communicatively couples various system components including the system memory to the processing unit 1021 when the system is in an operational state. The system bus 1023 may be any of several types of bus structures including a memory bus or memory controller, a peripheral bus, and a local bus using any of a variety of bus architectures. The system memory may include read only memory (ROM) 1024 and random access memory (RAM) 1025. A basic input/output system 1026 (BIOS), containing the basic routines that help to transfer information between elements within the computer 1020, such as during start up, is stored in ROM 1024. The computer 1020 may further include a hard disk drive 1027 for reading from and writing to a hard disk (not shown), a magnetic disk drive 1028 for reading from or writing to a removable magnetic disk 1029, and/or an optical disk drive 1030 for reading from or writing to a removable optical disk 1031 such as a CD ROM or other optical media. The hard disk drive 1027, magnetic disk drive 1028, and optical disk drive 1030 are shown as connected to the system bus 1023 by a hard disk drive interface 1032, a magnetic disk drive interface 1033, and an optical drive interface 1034, respectively. The drives and their associated computer-readable media provide non-volatile storage of computer readable instructions, data structures, program modules and other data for the computer 1020. Although the exemplary environment described herein employs a hard disk, a removable magnetic disk 1029 and/or a removable optical disk 1031, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media that may include an operating system 1035, one or more application programs 1036, other program modules 1037 and program data 1038. Computer-readable media can be any available media that can be accessed by computer 1020 and includes both volatile and non-volatile media, removable and non-removable media. By way of example, and not limitation, computer readable media may comprise computer storage media and communication media. Computer storage media may include both volatile and non-volatile, removable and non-removable media implemented in any method or technology for storage of information such as computer readable instructions, data structures, program modules or other data. Computer storage media includes, but is not limited to, RAM 1025, ROM 1024, EEPROM, flash memory or other memory technology, CD-ROM, digital versatile disks (DVD) or other optical disk storage 1031, magnetic cassettes, magnetic tape, magnetic disk storage 1029 or other magnetic storage devices, or any other medium which can be used to store the desired information and which can be accessed by computer 1020. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Upon execution by the processing unit, the computer-readable instructions cause the actions described in more detail below to be carried out. A user may enter commands and information into the computer 1020 through input devices such as a keyboard 1040 and/or pointing device 1042. These and other input devices may be connected to the processing unit 1021 through a serial port interface 1046 that is coupled to the system bus, but may be connected by other interfaces, such as a parallel port, game port or universal serial bus (USB). A display 1047 or other type of display device can also be connected to the system bus 1023 via an interface, such as a video adapter 1048. In addition to the display 1047, computers typically include other peripheral output devices (not shown), such as speakers and printers. The exemplary system of FIG. 7 also includes a host adapter 1055, Small Computer System Interface (SCSI) bus 1056, and an external storage device 1062 connected to the SCSI bus 1056.

Additionally, the computer 1020 may operate in a networked environment using logical connections to one or more remote computers, such as a remote computer 1049. The remote computer 1049 may be another computer, a server, a router, a network PC, a peer device or other common network node, and typically can include many or all of the elements described above relative to the computer 1020, although only a memory storage device 1050 has been illustrated in FIG. 7. The logical connections depicted in FIG. 7 may include a local area network (LAN) 1051 and a wide area network (WAN) 1052. Such networking environments may be commonplace in offices, enterprise wide computer networks, intranets and the Internet.

When used in a LAN networking environment, the computer 1020 may be connected to the LAN 1051 through a network interface or adapter 1053. When used in a WAN networking environment, the computer 1020 can typically include a modem 1054 or other means for establishing communications over the wide area network 1052, such as the Internet. The modem 1054, which may be internal or external, can be connected to the system bus 1023 via the serial port interface 1046. In a networked environment, program modules depicted relative to the computer 1020, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

Methods and systems for capturing and reporting relevant crop genotype-specific performance information to plant scientists or other researchers have been disclosed. Numerous variations, alternatives, and options are contemplated. These include variations in the type of crop, variations in the data collected, variations in the manner in which data is collected and/or transferred, variations in how the data is used by researchers, and other variations.

What is claimed is:

1. A method comprising:
receiving, from a producer, geo-referenced crop data that indicates performance of a crop at a production location and an identity of the crop at the production location;
associating, at a processor, genetic element data with the geo-referenced crop data; and
determining crop performance data indicative of performance of a genetic element, based on the association of genetic element data with the geo-referenced crop data.

2. The method of claim 1, wherein the genetic element data is received with the geo-referenced crop data.

3. The method of claim 1, wherein said associating comprises correlating the genetic element data to the identity of the crop at the production location.

4. The method of claim 1, wherein the identity of the crop at the production location comprises a particular hybrid or variety associated with the crop.

5. The method of claim 4, further comprising receiving feedback from the producer to the suitability of the particular hybrid or variety associated with the crop.

6. The method of claim 1, further comprising receiving additional data associated with the multipoint geo-referenced crop data, wherein the additional data comprises at least one of environmental data, physical data, management data, or biotic data.

7. The method of claim 1, wherein the geo-referenced crop data further comprises at least one of as-planted data or as-harvested data.

8. The method of claim 1, wherein the geo-referenced crop data comprises an environmental attribute at the location.

9. The method of claim 8, wherein the environmental attribute at the location comprises at least one of weather, soil moisture, precipitation, standing water, drought, solar radiation, photoperiod, latitude, elevation, soil type, climate, humidity, or temperature.

10. The method of claim 1, wherein the genetic element data further comprises at least one of a particular gene within the crop, a particular cDNA within the crop, a particular set of genes within the crop, a particular locus within the crop, or a particular genetic marker within the crop.

11. The method of claim 1, wherein the performance of the crop at the production location comprises a yield associated with the crop.

12. The method of claim 1, further comprising generating a map associated with the production location using the geo-referenced crop data.

13. The method of claim 12, wherein the map is a harvest map.

14. The method of claim 1, wherein the geo-referenced crop data is received from a precision agricultural system.

15. The method of claim 1, wherein the geo-referenced crop data further comprises crop management practices.

16. The method of claim 1, wherein the geo-referenced crop data further comprises phenotypic or genetic trait data.

17. The method of claim 1, wherein the geo-referenced crop data indicates data from one of a strip trial field, a split planter comparison field, or large block configurations.

18. A system comprising:
a processor; and
computing memory having stored therein instructions that when executed by the processor perform the following:
receiving geo-referenced crop data that indicates a yield of a crop at a production location and an identity of the crop at the production location;
associating, at a processor, genetic element data with the geo-referenced crop data; and
determining performance data indicative of performance of a genetic element, based on the association of the genetic element data with the geo-referenced crop data.

19. The system of claim 18, wherein the geo-referenced crop data is collected from a producer who grows the crop.

20. The system of claim 18, wherein said associating comprises correlating the genetic element data to the identity of the crop at the production location.

21. The system of claim 18, wherein the identity of the crop at the production location comprises a particular hybrid or variety.

22. The system of claim 18, wherein the geo-referenced crop data comprises an environmental attribute at the production location.

23. The system of claim 22, wherein the environmental attribute at the production location comprises at least one of weather, moisture, precipitation, standing water, drought, solar radiation, photoperiod, latitude, elevation, soil type, climate, humidity, or temperature.

24. The system of claim 18, wherein the genetic element data further comprises at least one of a particular gene within the crop, a particular cDNA within the crop, a particular set of genes within the crop, a particular locus within the crop, or a particular genetic marker within the crop.

25. The system of claim 18, further comprising generating a harvest map associated with the production location of the crop using the geo-referenced crop data.

26. The system of claim 18, wherein the geo-referenced crop data is received from a precision agricultural system.

27. The system of claim 18, wherein the geo-referenced crop data indicates data from one of a strip trial field, a split-planter comparison field, or large block configurations.

28. A computer-readable medium, the computer-readable medium having computer executable instructions stored thereon that, when executed, perform a method, comprising:
receiving, from a producer, geo-referenced crop data that indicates a yield of a crop at a production location and an identity of the crop at the production location;
associating, at a processor, genetic element data with the geo-referenced crop data, wherein the genetic element data corresponds to a particular hybrid or variety of the crop at the production location; and
determining performance data indicative of performance of a genetic element, based on the association of the genetic element data with the geo-referenced crop data.
